(19) United States
(12) Patent Application Publication
(10) Pub. No.: US 2025/0213406 A1
(43) Pub. Date: Jul. 3, 2025

(54) FRAME FOR A PATIENT CARRIER AND A PATIENT CARRIER APPARATUS

(71) Applicant: Arjo IP Holding Aktiebolag, Malmõ (SE)

(72) Inventors: Jon BACKMAN, Malmõ (SE); Anders Abjörnsson, Malmõ (SE)

(73) Assignee: Arjo IP Holding Aktiebolag, Malmõ (SE)

(21) Appl. No.: 18/881,488

(22) PCT Filed: Nov. 22, 2022
(86) PCT No.: PCT/EP2022/082878

§ 371 Date: Jan. 6, 2025

(30) Foreign Application Priority Data
Jul. 8, 2022 (SE) 2230226-9

(51) Int. Cl. A61G 5/10

(52) U.S. Cl. CPC A61G 5/1005

(57) ABSTRACT

A frame with wheels and a braking system for a patient carrier apparatus, which frame comprises a front, a back, a first side, and a second side, which wheels are arranged with the frame, which braking system comprises an actuator arranged to cooperate with a brake arrangement arranged to apply a braking motion against the wheels.

### FIELD OF THE INVENTION

The present invention relates to a frame for a patient carrier apparatus as well as to a patient carrier apparatus. Particularly, the present invention relates to a wheeled patient carrier apparatus arranged with a braking system for braking of the wheels.

### BACKGROUND OF THE INVENTION

Patient carrier apparatuses with wheels are commonly used for helping and supporting people for arranging movement or transfer from one location to another. Examples of patient carrier apparatuses are a seating arrangement with wheels, a bed with wheels, and others kind of carrier arrangement with wheels. Common to all these arrangements is they are wheeled. To avoid accidents and to facilitate the use of the wheeled patient carriers (for example in the moment when the patient is entering the patient carrier apparatus), the carriers are equipped with some kind of brake arrangement to brake the wheels, in order to prevent the patient carrier apparatus from moving.

An example of a brake arrangements for wheeled patient carriers is where each wheel is arranged with a brake arrangement. Upon braking, the user walks around the wheeled patient carrier and sets the brake arrangement in brake position for each wheel. A drawback with such an arrangement is that it takes time to set the wheeled patient carrier apparatus in braking position. Another possible drawback is that if the user does not set all wheels in brake position the patient carrier apparatus may still risk to move.

Another example of a brake arrangement for wheeled patient carrier apparatuses is where the wheels may be arranged in brake position via a mechanical mechanism from, for example, a handle arranged on the frame part of the wheeled patient carrier apparatus. An example of such an arrangement is presented in U.S. Pat. No. 6,860,495B2. A drawback of such an arrangement is that each wheel brake arrangement comprises a structure with many individual parts, connected to each other to function with the handle upon brake or release of the brake arrangement. Such a construction with many parts is expensive to manufacture, difficult to assemble, and difficult to monitor in regards of wear because of the many parts in the construction.

### SUMMARY OF THE INVENTION

An object of the present invention is to provide a frame for a patient carrier apparatus, as well as a patient carrier apparatus, with wheels and a brake system, which, upon either brake activation or release activation, simultaneously brakes or releases all the wheels. A further purpose of the invention is to provide a frame which comprises of few internal parts, which will facilitate assembly and maintenance compared to those of the prior art.

The objects are achieved with a frame for a patient carrier apparatus according to claim 1, and a patient carrier apparatus, according to claim 18.

The present invention is described to comprise a frame with wheels and a braking system for a patient carrier apparatus. The frame comprises a front, a back, a first side, and a second side. With the frame are wheels arranged. Further, the braking system comprises an actuator arranged to cooperate with a first link element. The first link element comprises a first end and a second end, and which first link element cooperates with break arrangements arranged to brake against the wheels. Further, the first end of the first link element is arranged to cooperate with a first brake arrangement arranged to brake against a first wheel, and the second end of the first link element is arranged to cooperate with a second break arrangement arranged to brake against a second wheel. As an effect, the link element consists of only one element cooperating with two wheels whereby, along the link element, there are no joints which may cause wear and friction between two adjoined elements.

Actuator in this text refers to a motor, for example an electric motor, responsible for moving and controlling a mechanism or system.

According to one embodiment the braking system comprises a second link element. Further, a first end of the second link element is arranged to cooperate with a third brake arrangement arranged to brake against a third wheel, and a second end of the second link element is arranged to cooperate with a fourth brake arrangement arranged to brake against a fourth wheel. An effect of a second link element is that it enables all wheels to be arranged to cooperate with the braking system and allows for all wheels to be monitored to either be in braking mode or release mode.

According to one embodiment the first link element and the second link element, between their respective first end and second end, comprises a respective first and second cooperation area and which each is arranged to cooperate with the actuator. The cooperation area is substantially centrally arranged along the link elements extension. An effect is that the cooperation area cooperates with the actuator.

According to one embodiment the actuator is arranged with a base element and which base element is arranged to the front of the frame. An effect of the base element is that it holds and secures the actuator in a firm and static position with respect to the frame.

According to one embodiment the base element is arranged with a first guide element and a second guide element for guiding the cooperation area of the first link element and the second link element to cooperate with the actuator. An effect of the guide element is that it guides the link element so that the link element's cooperation area from the guide element can cooperate with the actuator.

According to one embodiment comprises the base element in a direct vicinity of the first and second guide element a respective first and second slot. An effect of the respective first and second slot is that during use, tensions in the material of the base element may arise whereby the slots may reduce the likelihood of creations of tension spots. Tension spots which arise during use in a material may cause weakening and cracks, which may risk causing the base element to break. A further effect is that the slots facilitate making of the guide elements as they are part of the base element. During making, the guide elements are bent from a plane of the base element to a perpendicular arrangement, position, with respect to the base element.

According to one embodiment comprises the respective first and second guide element is arranged along a respective first and second side edge of the base element, and vertical arranged with respect to the base element, and angled with respect to the respective side edges extensions. An effect the arrangements of the guide elements is that they can guide the respective link with the respective cooperation towards the centre of the base element to uniformly cooperate with the actuator. The uniform cooperation enables the first and the second link to act simultaneously towards respective brake arrangements whereby all wheels can be placed in either brake position or release position.

According to one embodiment the first guide element is arranged at closer distance to a front of the frame compared to the second guide element. Further, the actuator is arranged with a turn member and cooperates with the first and the second link element. The actuator comprises an axis on which a turn member is arranged. The axis is arranged with a distance to the front which, lengthwise with respect to the front, is arranged between the respective distance of the respective guide elements. Therefore, an effect of the guide elements being positioned on different distances from the front thus enables the respective cooperation area of the respective link element to be guided and directed towards a respective end part of the turn member for cooperation.

According to one embodiment, the turn member comprises a first groove element and a second groove element. Further, the groove element is a groove wheel. The groove elements on the turn member may be arranged for turning or rotating. An effect is that the groove element guides the cooperation area of the link element from the guide element and to the guide element. A further effect of the groove element being a groove wheel, which is turnable and arranged with the turn member, is that wear between the cooperation area and the groove wheel is limited compared to if the cooperation area would be sliding around a fixed element on the turn member.

According to one embodiment, the link element has a U shape in its extension around the groove wheel and through two guide holes in the guide element, and in the extension between the two guide holes in the guide element towards the respective brake arrangement are the two extensions of the link element crossed with respect to each other. An effect of the link element being shaped in a U-shape around the groove wheel, whereby it cooperates with the turn member, is that the link element can be arranged as one element without any joints. A further effect of the U-shape is that it enables for simple and easy assembly and maintenance. An effect of crossing the link elements with respect to each other is that the curvature of the link elements can be made larger which reduces possible friction in the link elements during operation. However, for a construction where the patient carrier apparatuses might be of a larger model, then the radius of the link elements might be large enough whereby it is not necessary to have the link elements crossed.

According to one embodiment the link element is a wire. An effect of the wire is that it is flexible and durable. The wire is arranged inside a flexible pipe element in its extension which has the effect to uphold a certain stiffness and stability in guiding of the wire. Because the wire extends along parts of the frame, through the guide element and around the groove wheel, it is guided and arranged between two brake arrangement and the mentioned stiffness and stability help to keep the wire in position along the frame. Another effect of the link being a wire is that in a situation where the actuator would stop functioning, a user will be able to, with his or her hand, grip around the wire and pull the wire arranging the wheels into release position.

According to one embodiment the turn member is arranged for positioning between a brake position and a release position, which change of the position from either brake position to release position, or from release position to brake position, is a one movement of the turn member which affects all brake arrangements simultaneously. An effect of activating, braking, or releasing simultaneously for all brake arrangements, and thus also the respective wheels, is that the patient carrier apparatus may be stopped immediately as well as be released immediately to continue being moved. This may be of importance during, for example, downhill movement when immediate braking is needed. Braking all wheels simultaneously prevents the patient carrier apparatus from turning which could be the situation if, for example, only two wheels were in brake position. In hospital environments it is common that floors in rooms sometimes have a leaning floor surface to facilitate liquid or water to flow in one direction, for example towards a well in the floor if the floor is being cleaned. Such rooms can for example be a shower room or bathroom. In such a room, a patient might have to transfer from the current patient carrier apparatus, or chair, to another patient carrier apparatus, for example a bathroom chair. Common is that the transfer happens sideways between the chairs. During such transfer, it is very important that both chairs are stable with respect to the floor, and with all their wheels arranged in brake position to avoid occurrence of any movements of the chairs during the transfer.

According to one embodiment the braking system comprises a control unit which is arranged remotely from the actuator and which control unit is arranged to communicate with the actuator. Further, the control unit comprises a transmitter and is arranged to communicate wireless with a receiver arranged with the actuator. An effect of the control unit is that the person may hold the control unit simultaneously while helping a patient to for example be seated or lifted, and, depending on the situation, remotely brake or release the brakes on the wheels. The control unit may be in communication with the actuator either via a wire or via wireless communication. An effect of wireless communication is that it may facilitate movement around the patient carrier apparatus by a user while simultaneously being able to control the braking or releasing of the wheels on the patient carrier apparatus.

As mentioned above, the invention further also is described to relate to a patient carrier apparatus comprising a frame which comprises above named and discussed features.

### BRIEF DESCRIPTION OF THE DRAWINGS

The invention is described in more detail below with reference to the appended drawings in which:

FIG. 1 is an overview of a patient carrier assembly.

FIG. 2 is a view from above on the frame for the patient carrier assembly.

FIG. 3 is a side view of the frame for the patient carrier assembly.

FIG. 4 is a view on part of the brake system when being in brake position.

FIG. 5 is a view on part of the brake system when being in release position.

### DETAILED DESCRIPTION OF PREFERRED EMBODIMENT OF THE INVENTION

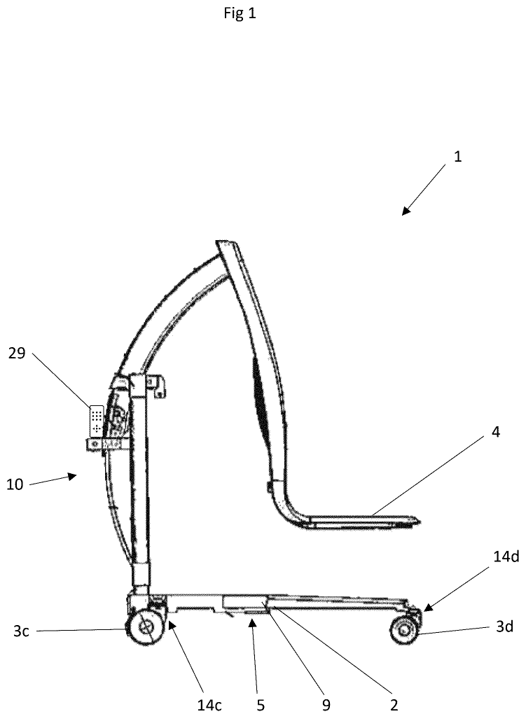

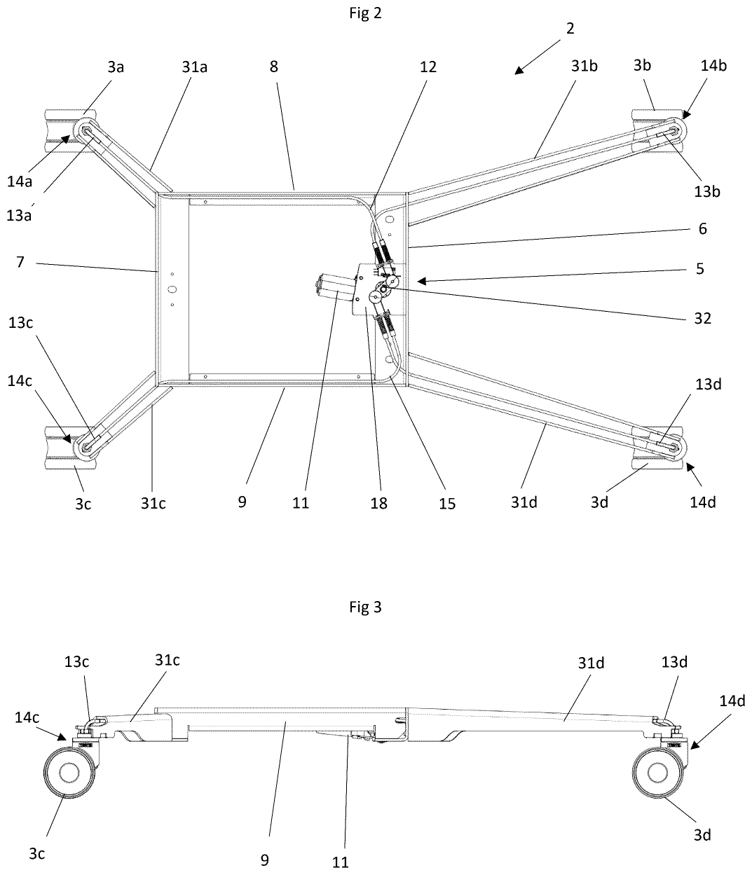

FIG. 1 illustrates a patient carrier assembly 1 or apparatus seen from one side 9. The patient carrier assembly 1 comprises a frame 2. The frame 2 is arranged with wheels 3a, 3b, as shown in FIGS. 2, and 3c, 3d. The patient carrier assembly 1 is further arranged with a patient base 4, which is arranged with the frame 2 via means 10. The means 10 may be a sub-frame which is connected to the frame 2. Further, the means 10 carry the patient base 4. In this example the patient base 4 is a chair. It may be understood that a patient base 4 may also be, for example, a bed for a patient to lie down on. Another example of a patient base 4 may be a combined seat and bed assembly. The patient carrier apparatus 1 is arranged with a control unit 29. The control unit 29 is arranged to communicate with a braking system 5 of the patient carrier apparatus 1. The control unit 29 is a portable remotely controlled unit, which may be carried by a user during operation of the patient carrier apparatus 1. The control unit 29 is arranged with a connection element, whereby it may be arranged on the patient carrier apparatus 1, especially when not in use. The control unit 29 is either arranged to communicate with the braking system 5 via a cable or via wireless communication technology, not shown in figure.

FIG. 2 illustrates the frame 2 as seen from above. The means 10 and the patient base 4 are not shown in FIG. 2. The frame 2 comprises a front end 6 and a back end 7 parallel to each other. Further, the frame 2 comprises a first side 8 and a second side 9 parallelly arranged to each other. In one embodiment, the front end 6, back end 7, first side 8, and the second side 9 together form a square with four corners. The frame 2 comprises a first leg 31a, a second leg 31b, a third leg 31c, and a fourth leg 31d. The first leg 31a is connected with a corner area where the back end 7 and the first side 8 of the frame 2 meet. The second leg 31b is connected with the corner area where the front end 6 and the first side 8 of the frame meet. The third leg 31c is connected with the corner area where the back end 7 and the second side of the frame 2 meet. The fourth leg 31d is connected with the corner area where the front end 6 and second side 9 of the frame 2 meet. The respective free ends of the legs 31a-d, which are not directly connected to the frame 2, each comprise a brake arrangement 14a-d and a wheel 3a-d. The first leg 31a and the third leg 31c have the same length. The second leg 31b and the fourth leg 31d have the same length. In one embodiment, the first leg 31a and the third leg 31b are each shorter than the second leg 31b and the fourth leg 31d. Alternative, the legs may have other length relative each other.

The braking system 5 comprises an actuator 11. In one embodiment, the actuator 11 is a motor, for example an electric motor. The actuator 11 is arranged inside the square of the frame 2, defined by the front end 6, the back end 7, the first side 8, and the second side 9. The actuator is arranged with a base element 18. The base element 18 comprises a forward arranged front edge 36, which is arranged against the inside of the front end 6 of the frame 2. The actuator 11 comprises an axis 32 which extends through the base element 18. The axis 32 is arranged within the frame 2, in an area within the frame as defined by the front end 6, the back end 7, the first side 8, and the second side 9. In the embodiment as shown in FIG. 2, the axis 32 is arranged towards a centre part of the front 6. The axis may be arranged in other position within the area as defined by the front end 6, the back end 7, the first side 8, and the second side 9. An effect of the axis 32 being arranged between the front end 6, the back end 7, the first side 8, and the second side 9 is that it is shielded of and protected from external elements and forces which by accident might come near the axis 32 during the use of the patient carrier apparatus 1.

The first link element 12 being a wire, comprises a first end 13a and a second end 13b. The second link element 15 being a wire, comprises a first end 13c and a second end 13d. With regards to the first link element 12, the first end 13a is arranged to the first brake arrangement 14a, arranged to apply a braking or releasing motion against the first wheel 3a. With regards to the first link element, the second end 13b is arranged to the second brake arrangement 14b, arranged to apply a braking or releasing motion against the second wheel 3b. With regards to the second link element 15, the first end 13a of the second link element 15 is arranged to the third brake arrangement 14c, arranged to apply a braking or releasing motion against the third wheel 3c. The second end 13d of the second link element 15 is arranged to the fourth brake arrangement 14d, arranged to apply a braking or releasing motion against the fourth wheel 3d. With regards to a substantially centrally arranged part on the first and second link elements 12, 15, the first and second link elements 12, 15 each cooperate with the actuator 11. The respective link elements 12, 15 are arranged and connected via fixation elements against the frame 2 in its extension from the place of the actuator 11 towards each wheel 3a-d.

The link element 12, 15, extending from the area of the actuator 11, to the respective brake arrangement 14a-b, 14c-d, is at a point within the square of the frame 2, crossed with regards to its respective extension towards the respective brake arrangement 14a-b, 14c-d. An effect of this is that radius of a curvature of the link element 12, 15, in the extension from the area the actuator 11, may be larger compared to if it were not crossed, whereby wear of the link element 12, 15, where it bends within the square of the frame 2, would have been greater. In an alternative embodiment where the frame 2 is larger, then that will have the effect there will be more space available within the frame 2. This extra space within the frame 2 may then have the further effect that the link elements 12, 15 will not have to be crossed as the radius in the extensions of the link elements 12, 15 will be large enough due to the larger frame 2.

FIG. 3 illustrates the frame 2 from the second side 9.

The legs 31c, 31d may have a n cross-section. The link element 12, 15 may be arranged and attached to the inside of the respective leg. Because of the n cross-section of the legs, the link elements 12, 15 are protected from above by the extension of the legs 31a-d. The ends 13c, 13d of the link element 12, 15 are connected and cooperate with the respective brake arrangements 14c, 14d. The actuator 11 is arranged within the square the frame 2. The height of the first side 8 and the second side 9 are arranged to substantially cover and protect the majority of the actuator 11, arranged between the first and second side 8, 9 from any possible external elements.

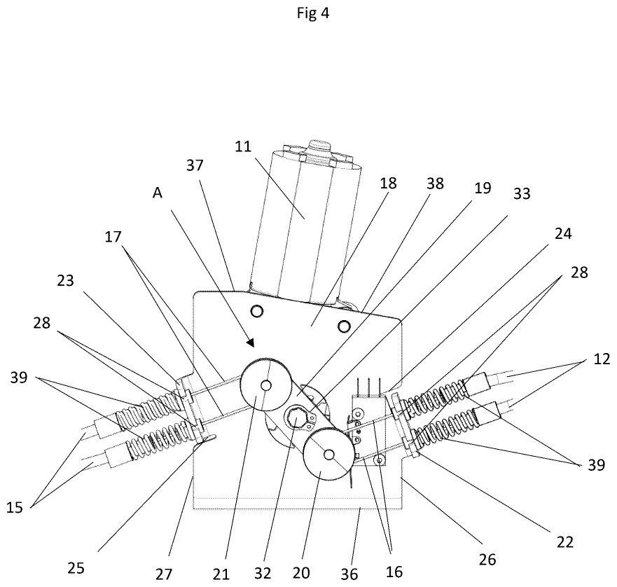

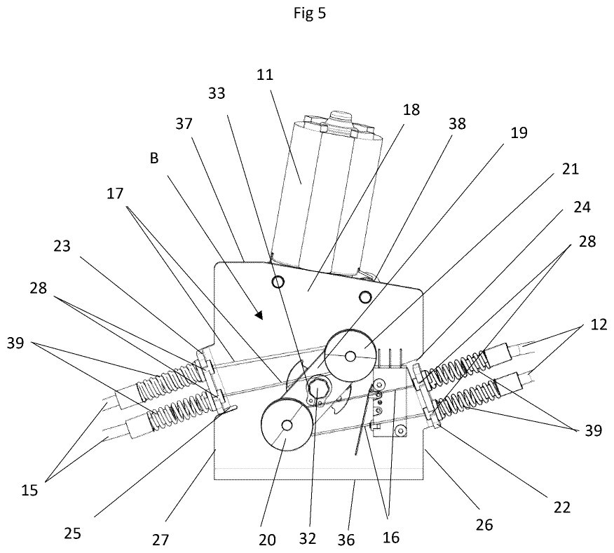

FIGS. 4 and 5 illustrate the actuator 11 as seen from above. The actuator 11 is arranged with the base element 18. The base element 18 comprises a front edge 36, a first side edge 26, a second side edge 27, and a short and long rear edge 37, 38. The front edge 36 of the base element 18 is arranged and attached against the inside of the front 6 of the frame 2, not shown in the figure.

The actuator 11 comprises an axis 32 extending through the base element 18. The axis 18 is arranged with a turn member 19. The turn member 19 is oblong in its shape. The turn member 19 is arranged to the axis 32 via a lock ring 33. At respective end points of the turn member 19 are a first groove element 20, which is the first groove wheel, and a second groove element 21 which is the second groove wheel arranged. The groove wheels 20, 21 are rotatably arranged with the turn member 19.

The base element 18 is arranged with a first guide element 22 which is arranged along the first side edge 26. Along the second side edge 27, a second guide element 23 is arranged. The guide elements 22, 23 are vertically arranged with respect to the base element 18. The first guide element 22 is arranged at a distance closer to the front edge 36 compared to second guide element 23. The first guide element 22 is angled with respect to the first side edge 26, such that a side of the first guide element 22, facing towards the axis 32, is facing towards the front edge 36. The second guide element 23 is angled with respect to the second side edge 27, such that a side of the second guide element 23, facing towards the axis 32, is facing the short and long rear edge 37, 38. The guide elements 22, 23 are each arranged with two guide holes 28. The guide holes 28 are arranged to position and secure the respective link elements 12, 15, coming from the respective connected pair of brake arrangements 14a-14d, whereby a respective first and second cooperation area 16, 17 of the respective link element 12, 15, from the respective two guide holes 28 form a respective U-shape in their extension around the respective first and second groove wheel 20, 21. In the brake position A, as well as in the release position B, the first guide element 22 faces towards the first groove wheel 20 in a substantial perpendicular direction from the first guide element 22. Simultaneously, in the brake position A, as well as in the release position B, the second guide element 23 faces towards the first groove wheel 21 in a substantial perpendicular direction from the second guide element 23.

On the base element 18 along the first side edge 26, a first slot 24 is arranged. The first slot 24 is arranged in direct vicinity to the first guide element 22, between the first guide element 22 and the long rear edge 38. Along the second side edge 27, a second slot 25 is arranged. The second slot 25 is arranged in direct vicinity to the second guide element 23, between the second guide element 23 and the front edge 36. The slots 24, 25 facilitates making of the guide elements 22, 23 when being bent, or angled, from a plane from the base element 18. Further, the slots 24, 25 may reduce stress points which can arise in the material of the base element 18 during use.

The first and second link elements 12, 15 are arranged with wire springs 39 in their respective arrangements with the guide holes 28 of the first and second guide element 22, 23. The link elements 12, 15 is a wire arranged within a tube made of flexible material, which extend from the respective brake arrangement, to the guide element 22, 23. The wire spring 39 make sure the tube is pressed towards the brake arrangements 14a-d, whereby the wire may be operated inside the tube.

During operation of the braking system 5, the turn member 19 may be positioned in brake position A, which is illustrated in FIG. 4. In brake position A, the turn member 19 is arranged with its ends and groove wheel 20, 21 close to the respective guide element 22, 23, compared to the turn member 19 being in release position B, see FIG. 5. The brake system 5 is arranged so that its default position is brake position A.

Hereinbefore it has been described that the patient carrier apparatus may be related to primarily a chair. It will be appreciated that the principles described above with a braking system may be applied to other types of patient carrier apparatus such as hospital beds.

### REFERENCE SIGNS

1 patient carrier apparatus
2 frame
3a-d wheels
   3a first wheel
   3b second wheel
   3c third wheel
   3d fourth wheel
4 patient base
5 braking system
6 front end
7 back end
8 first side
9 second side
10 means
11 actuator
12 first link element
13a-d ends
   13a, c first end
   13b, d second end
14a-d brake arrangements
   14a first brake arrangement
   14b second brake arrangement
   14c third brake arrangement
   14d fourth brake arrangement
15 second link element
16 first cooperation area
17 second cooperation area
18 base element
19 turn member
20 first groove element
21 second groove element
22 first guide element
23 second guide element
24 first slot
25 second slot
26 first side edge
27 second side edge
28 guide holes
29 control unit
31a first leg
31b second leg
31c third leg
31d fourth leg
32 axis
33 lock ring
36 front edge
37 short rear edge
38 long rear edge
39 wire spring
A brake position
B release position

1. A frame with wheels and a braking system for a patient carrier apparatus,
wherein the frame comprises a front, a back, a first side, and a second side,
wherein the wheels are arranged with the frame,
wherein the braking system comprises an actuator arranged to cooperate with a brake arrangement arranged to apply a braking motion against the wheels, and
wherein the braking system comprises a first link element, wherein a first end of the first link element is arranged to cooperate with a first break arrangement arranged to apply a braking motion against a first wheel, and wherein a second end of the first link element is arranged to cooperate with a second break arrangement arranged to apply a braking motion against a second wheel.

2. The frame according to claim 1, wherein the braking system comprises a second link element.

3. The frame according to claim 2, wherein a first end of the second link element is arranged to cooperate with a third brake arrangement arranged to apply a braking motion against a third wheel, and a second end of the second link element is arranged to cooperate with a fourth brake arrangement arranged to apply a braking motion against a fourth wheel.

4. The frame according to claim 3, wherein the first link element and the second link element, between their respective first end and second end, comprises a respective first and second cooperation area and which each is arranged to cooperate with the actuator.

5. The frame according to claim 1, wherein the actuator is arranged with a base element and which base element is arranged to the front of the frame.

6. The frame according to claim 5, wherein the base element is arranged with a first guide element and a second guide element for guiding the cooperation area of the first link element and the second link element to cooperate with the actuator.

7. The frame according to claim 6, wherein the respective first and second guide element is arranged along a respective first and second side edge of the base element, and vertical arranged with respect to the base element, and angled with respect to the respective side edges extensions.

8. The frame according to claim 6, wherein the first guide element is arranged at closer distance to a front of the frame compared to the second guide element.

9. The frame according to claim 5, wherein the actuator is arranged with a turn member and cooperates with the first and the second link element.

10. The frame according to claim 9, wherein the turn member comprises a first groove element and a second groove element.

11. The frame according to claim 10, wherein the groove element is a groove wheel.

12. The frame according to claim 11, wherein the link element has a U shape in its extension around the groove wheel and through two guide holes in the guide element, and in the extension between the two guide holes in the guide element towards the respective brake arrangement are the two extensions of the link element crossed with respect to each other.

13. The frame according to claim 1, wherein the link element is a wire.

14. The frame according to claim 9, wherein the turn member is arranged for positioning between a brake position and a release position, which change of the position from either brake position to release position, or from release position to brake position, is a one movement of the turn member which affects all brake arrangements simultaneously.

15. The frame according to claims 1, wherein the braking system comprises a control unit which is arranged remotely from the actuator and which control unit is arranged to communicate with the actuator.

16. The frame according to claim 15, wherein the control unit comprises a transmitter and is arranged to communicate wireless with a receiver arranged with the actuator.

17. A patient carrier apparatus comprising the frame according to claim 1.
